(19) United States
(12) Patent Application Publication
(10) Pub. No.: US 2008/0227665 A1
(43) Pub. Date: Sep. 18, 2008

(54) Aqueous-Based Insulating Fluids and Related Methods

(76) Inventors: Ryan Ezell, The Woodlands, TX (US); Jeff Miller, Spring, TX (US); Greg Perez, Pearland, TX (US)

Correspondence Address: Craig W. Roddy;Halliburton Energy Services, Inc., 2600 South 2nd Street, P. O. Bo 1431, Duncan, OK, 73536, US

(21) Appl. No.: 11/685,909

(22) Filed: Mar. 14, 2007

(51) Int. Cl. C09K 8/12

(52) U.S. Cl. 507/121

(57) ABSTRACT

Provided herein are methods that include In one embodiment, the present invention provides a method comprising: providing an annulus between a first tubing and a second tubing; providing an aqueous-based insulating fluid that comprises an aqueous base fluid, a water-miscible organic liquid, and a synthetic polymer; and placing the aqueous-based insulating fluid in the annulus. Another method provided is a method comprising: providing a tubing comprising a first fluid located within a well bore such that an annulus is formed between the tubing and a surface of the well bore; providing an aqueous-based insulating fluid that comprises an aqueous base fluid, a water-miscible organic liquid, and a synthetic polymer; and placing the aqueous-based insulating fluid in the annulus.

### BACKGROUND

The present invention relates to insulating fluids, and more particularly, to aqueous-based insulating fluids that have greater stability at high temperatures with lower thermal conductivity that may be used, for example, in applications requiring an insulating fluid such as pipeline and subterranean applications (e.g., to insulate petroleum production conduits).

Insulating fluids are often used in subterranean operations wherein the fluid is placed into an annulus between a first tubing and a second tubing or the walls of a well bore. The insulating fluid acts to insulate a first fluid (e.g., a hydrocarbon fluid) that may be located within the first tubing from the environment surrounding the first tubing or the second tubing to enable optimum recovery of the hydrocarbon fluid. For instance, if the surrounding environment is very cold, the insulating fluid is thought to protect the first fluid in the first tubing from the environment so that it can efficiently flow through the production tubing, e.g., the first tubing, to other facilities. This is desirable because heat transfer can cause problems such as the precipitation of heavier hydrocarbons, severe reductions in flow rate, and in some cases, casing collapse. Additionally, when used in packer applications, a required amount of hydrostatic head pressure is needed. Thus, higher density insulating fluids are often used for this reason as well to provide the requisite hydrostatic force.

Such fluids also may be used for similar applications involving pipelines for similar purposes, e.g., to protect a fluid located within the pipeline from the surrounding environmental conditions so that the fluid can efficiently flow through the pipeline. Insulating fluids can be used in other insulating applications as well wherein it is desirable to control heat transfer. These applications may or may not involve hydrocarbons.

Beneficial insulating fluids preferably have a low inherent thermal conductivity, and also should remain gelled to prevent, inter alia, convection currents that could carry heat away. Additionally, preferred insulating fluids should be aqueous-based, and easy to handle and use. Moreover, preferred fluids should tolerate high temperatures (e.g., temperatures of 240° F. or above) for long periods of time for optimum performance.

Conventional aqueous-based insulating fluids have been subject to many drawbacks. First, many have associated temperature limitations. Typically, most aqueous-based insulating fluids are only stable up to 240° F. for relatively short periods of time. This can be problematic because it can result in premature degradation of the fluid, which can cause the fluid not to perform its desired function with respect to insulating the first fluid. A second common limitation of many conventional aqueous-based insulating fluids is their density range. Typically, these fluids have an upper density limit of 12.5 ppg. Oftentimes, higher densities are desirable to maintain adequate pressure for the chosen application. Additionally, most aqueous-based insulating fluids have excessive thermal conductivities, which means that these fluids are not as efficient or effective at controlling conductive heat transfer. Moreover, when a viscosified fluid is required to eliminate convective currents, oftentimes to obtain the required viscosity in current aqueous-based fluids, the fluids may become too thick to be able to pump into place. Some aqueous-based fluids also can have different salt tolerances that may not be compatible with various brines used, which limits the operators' options as to what fluids to use in certain circumstances.

In some instances, insulating fluids may be oil-based. Certain oil-based fluids may offer an advantage because they may have lower thermal conductivity as compared to their aqueous counterparts. However, many disadvantages are associated with these fluids as well. First, oil-based insulating fluids can be hard to “weight up,” meaning that it may be hard to obtain the necessary density required for an application. Secondly, oil-based fluids may present toxicity and other environmental issues that must be managed, especially when such fluids are used in sub-sea applications. Additionally, there can be interface issues if aqueous completion fluids are used. Another complication presented when using oil-based insulating fluids is the concern about their compatibility with any elastomeric seals that may be present along the first tubing line.

Another method that may be employed to insulate a first tubing involves using vacuum insulated tubing. However, this method also can present disadvantages. First, when the vacuum tubing is installed on a completion string, sections of the vacuum tubing can fail. This can be a costly problem involving a lot of down time. In severe cases, the first tubing can collapse. Secondly, vacuum insulated tubing can be very costly and hard to place. Moreover, in many instances, heat transfer at the junctions or connective joints in the vacuum tubings can be problematic. These may lead to “hot spots” in the tubings.

### SUMMARY

The present invention relates to insulating fluids, and more particularly, to aqueous-based insulating fluids that have greater stability at high temperatures with lower thermal conductivity that may be used, for example, in applications requiring an insulating fluid such as pipeline and subterranean applications (e.g., to insulate petroleum production conduits).

In one embodiment, the present invention provides a method comprising: providing an annulus between a first tubing and a second tubing; providing an aqueous-based insulating fluid that comprises an aqueous base fluid, a water-miscible organic liquid, and a synthetic polymer; and placing the aqueous-based insulating fluid in the annulus.

In one embodiment, the present invention provides a method comprising: providing a tubing containing a first fluid located within a well bore such that an annulus is formed between the tubing and a surface of the well bore; providing an aqueous-based insulating fluid that comprises an aqueous base fluid, a water-miscible organic liquid, and a synthetic polymer; and placing the aqueous-based insulating fluid in the annulus.

In one embodiment, the present invention provides a method comprising: providing a first tubing that comprises at least a portion of a pipeline that contains a first fluid; providing a second tubing that substantially surrounds the first tubing thus creating an annulus between the first tubing and the second tubing; providing an aqueous-based insulating fluid that comprises an aqueous base fluid, a water-miscible organic liquid, and a synthetic polymer; and placing the aqueous-based insulating fluid in the annulus.

In one embodiment, the present invention provides an aqueous-based insulating fluid that comprises an aqueous base fluid, a water-miscible organic liquid, and a synthetic polymer.

In another embodiment, the present invention provides a method of forming an aqueous-based insulating fluid comprising: mixing an aqueous base fluid and a water-miscible organic liquid to form a mixture; adding at least one synthetic polymer to the mixture; allowing the polymer to hydrate; optionally adding a crosslinking agent to the mixture comprising the synthetic polymer to crosslink the synthetic polymer; placing the mixture comprising the synthetic polymer in a chosen location; allowing the mixture comprising the synthetic polymer to activate to form a gel therein.

The features and advantages of the present invention will be readily apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 lists the materials used in the formulations and the amounts thereof as described in the Examples section.

FIG. 2 illustrates data from a fluid that was heated at 190° F. for 5000 minutes to activate the crosslinking agent and provide an increase in viscosity.

### DESCRIPTION OF PREFERRED EMBODIMENTS

The present invention relates to insulating fluids, and more particularly, to aqueous-based insulating fluids that have greater stability at high temperatures with lower thermal conductivity that may be used, for example, in applications requiring an insulating fluid such as pipeline and subterranean applications (e.g., to insulate petroleum production conduits). The aqueous-based insulating fluids of the present invention may be used in any application requiring an insulating fluid. Preferably, they may be used in pipeline and subterranean applications.

The improved aqueous-based insulating fluids and methods of the present invention present many potential advantages. One of these many advantages is that the fluids may have enhanced thermal stability, which enables them to be beneficially used in many applications. Secondly, in some embodiments, the aqueous-based insulating fluids of the present invention may have higher densities than conventional aqueous-based insulating fluids, and therefore, present a distinct advantage in that respect. Additionally, the aqueous-based insulating fluids of the present invention have relatively low thermal conductivity, which is thought to be especially beneficial in certain applications. In some embodiments, these fluids are believed to be very durable. Moreover, in some embodiments, the fluids of the present invention offer aqueous-based viscous insulating fluids with a broad fluid density range, decreased thermal conductivity, and stable gel properties at temperatures exceeding those of current industry standards. Another potential advantage is that these fluids may prevent the formation of hydrates within the insulating fluids themselves or the fluids being insulated. Other advantages and objects of the invention may be apparent to one skilled in the art with the benefit of this disclosure.

In certain embodiments, the aqueous-based insulating fluids of the present invention comprise an aqueous base fluid, a water-miscible organic liquid, and a synthetic polymer. In some instances, the polymer may be crosslinked by using or adding to the fluid an appropriate crosslinking agent. Thus, the term “polymer” as used herein refers to oligomers, copolymers, terpolymers and the like, which may or may not be crosslinked. Optionally, the aqueous-based insulating fluids of the present invention may comprise other additives such as corrosion inhibitors, pH modifiers, biocides, glass beads, hollow spheres (e.g., hollow microspheres), rheology modifiers, buffers, hydrate inhibitors, breakers, tracers, additional weighting agents, viscosifiers, surfactants, and combinations of any of these. Other additives may be appropriate as well and beneficially used in conjunction with the aqueous-based insulating fluids of the present invention as may be recognized by one skilled in the art with the benefit of this disclosure.

The aqueous base fluids that may be used in the aqueous-based insulating fluids of the present invention include any aqueous fluid suitable for use in insulating, subterranean, or pipeline applications. In some instances, brines may be preferred, for example, when a relatively denser aqueous-based insulating fluid is desired (e.g., density of 10.5 ppg or greater). Suitable brines include, but are not limited to: NaCl, NaBr, KCl, CaCl₂, CaBr₂, ZrBr₂, sodium carbonate, sodium formate, potassium formate, cesium formate, and combinations and derivatives of these brines. Others may be appropriate as well. The specific brine used may be dictated by the desired density of the resulting aqueous-based insulating fluid or for compatibility with other completion fluid brines that may be present. Denser brines may be useful in some instances. A density that is suitable for the application at issue should be used as recognized by one skilled in the art with the benefit of this disclosure. When deciding how much of an aqueous fluid to include, a general guideline to follow is that the aqueous fluid component should comprise the balance of a high temperature aqueous-based insulating fluid after considering the amount of the other components present therein.

The water-miscible organic liquids that may be included in the aqueous-based insulating fluids of the present invention include water-miscible materials having relatively low thermal conductivity (e.g., about half as conductive as water or less). By “water-miscible,” it is meant that about 5 grams or more of the organic liquid will disperse in 100 grams of water. Suitable water-miscible organic liquids include, but are not limited to, esters, amines, alcohols, polyols, glycol ethers, or combinations and derivatives of these. Examples of suitable esters include low molecular weight esters; specific examples include, but are not limited to, methylformate, methyl acetate, and ethyl acetate. Combinations and derivatives are also suitable. Examples of suitable amines include low molecular weight amines; specific examples include, but are not limited to, diethyl amine, 2-aminoethanol, and 2-(dimethylamino)ethanol. Combinations and derivatives are also suitable. Examples of suitable alcohols include methanol, ethanol, propanol, isopropanol, and the like. Combinations and derivatives are also suitable. Examples of glycol ethers include ethylene glycol butyl ether, diethylene glycol methyl ether, dipropylene glycol methyl ether, tripropylene glycol methyl ether, and the like. Combinations and derivatives are also suitable. Of these, polyols are generally preferred in most cases over the other liquids since they generally are thought to exhibit greater thermal and chemical stability, higher flash point values, and are more benign with respect to elastomeric materials.

Suitable polyols are those aliphatic alcohols containing two or more hydroxy groups. It is preferred that the polyol be at least partially water-miscible. Examples of suitable polyols that may be used in the aqueous-based insulating fluids of this invention include, but are not limited to, water-soluble diols such as ethylene glycols, propylene glycols, polyethylene glycols, polypropylene glycols, diethylene glycols, triethylene glycols, dipropylene glycols and tripropylene glycols, combinations of these glycols, their derivatives, and reaction products formed by reacting ethylene and propylene oxide or polyethylene glycols and polypropylene glycols with active hydrogen base compounds (e.g., polyalcohols, polycarboxylic acids, polyamines, or polyphenols). The polyglycols of ethylene generally are thought to be water-miscible at molecular weights at least as high as 20,000. The polyglycols of propylene, although giving slightly better grinding efficiency than the ethylene glycols, are thought to be water-miscible up to molecular weights of only about 1,000. Other glycols possibly contemplated include neopentyl glycol, pentanediols, butanediols, and such unsaturated diols as butyne diols and butene diols. In addition to the diols, the triol, glycerol, and such derivatives as ethylene or propylene oxide adducts may be used. Other higher polyols may include pentaerythritol. Another class of polyhydroxy alcohols contemplated is the sugar alcohols. The sugar alcohols are obtained by reduction of carbohydrates and differ greatly from the above-mentioned polyols. Combinations and derivatives of these are suitable as well.

The choice of polyol to be used is largely dependent on the desired density of the fluid. Other factors to consider include thermal conductivity. For higher density fluids (e.g., 10.5 ppg or higher), a higher density polyol may be preferred, for instance, triethylene glycol or glycerol may be desirable in some instances. For lower density applications, ethylene or propylene glycol may be used. In some instances, more salt may be necessary to adequately weight the fluid to the desired density. In certain embodiments, the amount of polyol that should be used may be governed by the thermal conductivity ceiling of the fluid and the desired density of the fluid. If the thermal conductivity ceiling is 0.17 BTU/hft° F., then the concentration of the polyol may be from about 40% to about 99% of a high temperature aqueous-based insulating fluid of the present invention. A more preferred range could be from about 70% to about 99%.

Examples of synthetic polymers that may be suitable for use in the present invention include, but are not limited to, acrylic acid polymers, acrylic acid ester polymers, acrylic acid derivative polymers, acrylic acid homopolymers, acrylic acid ester homopolymers (such as poly(methyl acrylate), poly(butyl acrylate), and poly(2-ethylhexyl acrylate)), acrylic acid ester co-polymers, methacrylic acid derivative polymers, methacrylic acid homopolymers, methacrylic acid ester homopolymers (such as poly(methyl methacrylate), polyacrylamide homopolymer, n-vinyl pyrolidone and polyacrylamide copolymers, poly(butyl methacrylate), and poly(2-ethylhexyl methacrylate)), n-vinyl pyrolidone, acrylamido-methyl-propane sulfonate polymers, acrylamido-methyl-propane sulfonate derivative polymers, acrylamido-methyl-propane sulfonate co-polymers, and acrylic acid/acrylamido-methyl-propane sulfonate copolymers, and combinations thereof. Copolymers and terpolymers may be suitable as well. Mixtures of any of these of polymers may be suitable as well. In preferred embodiments, the polymer should be at least partially water soluble. Suitable polymers can be cationic, anionic, nonionic, or zwitterionic. In certain embodiments, the polymer should comprise from about 0.1% to about 15% weight by volume of the fluid, and more preferably, from about 0.5% to about 4%.

To obtain the desired gel characteristics and thermal stability for an aqueous-based insulating fluid of the present invention, the polymer included in the fluid may be crosslinked by an appropriate crosslinking agent. In those embodiments of the present invention wherein it is desirable to crosslink the polymer, optionally and preferably, one or more crosslinking agents may be added to the fluid to crosslink the polymer.

One type of suitable crosslinking agent is a combination of a phenolic component (or a phenolic precursor) and formaldehyde (or formaldehyde precursor). Suitable phenolic components or phenolic precursors include, but are not limited to, phenols, hydroquinone, salicylic acid, salicylamide, aspirin, methyl-p-hydroxybenzoate, phenyl acetate, phenyl salicylate, o-aminobenzoic acid, p-aminobenzoic acid, m-aminophenol, furfuryl alcohol, and benzoic acid. Suitable formaldehyde precursors may include, but are not limited to, hexamethylenetetramine, glyoxal, and 1,3,5-trioxane. This crosslinking agent system needs approximately 250° F. to thermally activate to crosslink the polymer. Another type of suitable crosslinking agent is polyalkylimine. This crosslinking agent needs approximately 90° F. to activate to crosslink the polymer. This crosslinking agent may be used alone or in conjunction with any of the other crosslinking agents discussed herein.

Another type of crosslinking agent that may be used includes non-toxic organic crosslinking agents that are free from metal ions. Examples of such organic cross-linking agents are polyalkyleneimines (e.g., polyethyleneimine), polyalkylenepolyamines and mixtures thereof. In addition, water-soluble polyfunctional aliphatic amines, arylalkylamines and heteroarylalkylamines may be utilized.

When included, suitable crosslinking agents may be present in the fluids of the present invention in an amount sufficient to provide, inter alia, the desired degree of crosslinking. In certain embodiments, the crosslinking agent or agents may be present in the fluids of the present invention in an amount in the range of from about 0.0005% to about 10% weight by volume of the fluid. In certain embodiments, the crosslinking agent may be present in the fluids of the present invention in an amount in the range of from about 0.001% to about 5% weight by volume of the fluid. One of ordinary skill in the art, with the benefit of this disclosure, will recognize the appropriate amount of crosslinking agent to include in a fluid of the present invention based on, among other things, the temperature conditions of a particular application, the type of polymer(s) used, the molecular weight of the polymer(s), the desired degree of viscosification, and/or the pH of the fluid.

Although any suitable method for forming the insulating fluids of the present invention may be used, in some embodiments, an aqueous-based insulating fluid of the present invention may be formulated at ambient temperature and pressure conditions by mixing water and a chosen water-miscible organic liquid. The water and water-miscible organic liquid preferably should be mixed so that the water-miscible organic liquid is miscible in the water. The chosen polymer may then be added and mixed into the water and water-miscible organic liquid mixture until the polymer is hydrated. If desired, a crosslinking agent may be added. If used, it should be dispersed in the mixture. Crosslinking, however, generally should not take place until thermal activation, which preferably, in subterranean applications, occurs downhole; this may alleviate any pumping difficulties that might arise as a result of activation before placement. Activation results in the fluid forming a gel. The term “gel,” as used herein, and its derivatives refers to a semi-solid, jelly-like state assumed by some colloidal dispersions. Any chosen additives may be added at any time prior to activation. Preferably, any additives are dispersed within the mixture. Once activated, the gel should stay in place and be durable with negligible syneresis.

Once gelled, one method of removing the gel may comprise diluting or breaking the crosslinks and/or the polymer structure within the gel using an appropriate method and/or composition to allow recovery or removal of the gel. Another method could involve physical removal of the gel by, for example, air or liquid.

In some embodiments, the aqueous-based insulating fluids of the present invention may be prepared on-the-fly at a well-site or pipeline location. In other embodiments, the aqueous-based insulating fluids of the present invention may be prepared off-site and transported to the site of use. In transporting the fluids, one should be mindful of the activation temperature of the fluid.

In one embodiment, the present invention provides a method comprising: providing a first tubing; providing a second tubing that substantially surrounds the first tubing thus creating an annulus between the first tubing and the second tubing; providing an aqueous-based insulating fluid that comprises an aqueous base fluid, a polyol, and a polymer; and placing the aqueous-based insulating fluid in the annulus. The tubings may have any shape appropriate for a chosen application. In some instances, the second tubing may not be the same length as the first tubing. In some instances, the tubing may comprise a portion of a larger apparatus. In some instances, the aqueous-based insulating fluid may be in contact with the entire first tubing from end to end, but in other situations, the aqueous-based insulating fluid may only be placed in a portion of the annulus and thus only contact a portion of the first tubing. In some instances, the first tubing may be production tubing located within a well bore. The production tubing may be located in an off-shore location. In other instances, the production tubing may be located in a cold climate. In other instances, the first tubing may be a pipeline capable of transporting a fluid from one location to a second location.

In one embodiment, the present invention provides a method comprising: providing a first tubing; providing a second tubing that substantially surrounds the first tubing thus creating an annulus between the first tubing and the second tubing; providing an aqueous-based insulating fluid that comprises an aqueous base fluid, a water-miscible organic liquid, and a synthetic polymer; and placing the aqueous-based insulating fluid in the annulus.

In one embodiment, the present invention provides a method comprising: providing a tubing containing a first fluid located within a well bore such that an annulus is formed between the tubing and a surface of the well bore; providing an aqueous-based insulating fluid that comprises an aqueous base fluid, a water-miscible organic liquid, and a synthetic polymer; and placing the aqueous-based insulating fluid in the annulus.

In one embodiment, the present invention provides a method comprising: providing a first tubing that comprises at least a portion of a pipeline that contains a first fluid; providing a second tubing that substantially surrounds the first tubing thus creating an annulus between the first tubing and the second tubing; providing an aqueous-based insulating fluid that comprises an aqueous base fluid, a water-miscible organic liquid, and a synthetic polymer; and placing the aqueous-based insulating fluid in the annulus.

In one embodiment, the present invention provides an aqueous-based insulating fluid that comprises an aqueous base fluid, a water-miscible organic liquid, and a synthetic polymer.

In another embodiment, the present invention provides a method of forming an aqueous-based insulating fluid comprising: mixing an aqueous base fluid and a water-miscible organic liquid to form a mixture; adding at least one synthetic polymer to the mixture; allowing the polymer to hydrate; optionally adding a crosslinking agent to the mixture comprising the synthetic polymer to crosslink the synthetic polymer; placing the mixture comprising the synthetic polymer in a chosen location; allowing the mixture comprising the synthetic polymer to activate to form a gel therein.

To facilitate a better understanding of the present invention, the following examples of certain aspects of some embodiments are given. In no way should the following examples be read to limit, or define, the entire scope of the invention.

### EXAMPLES

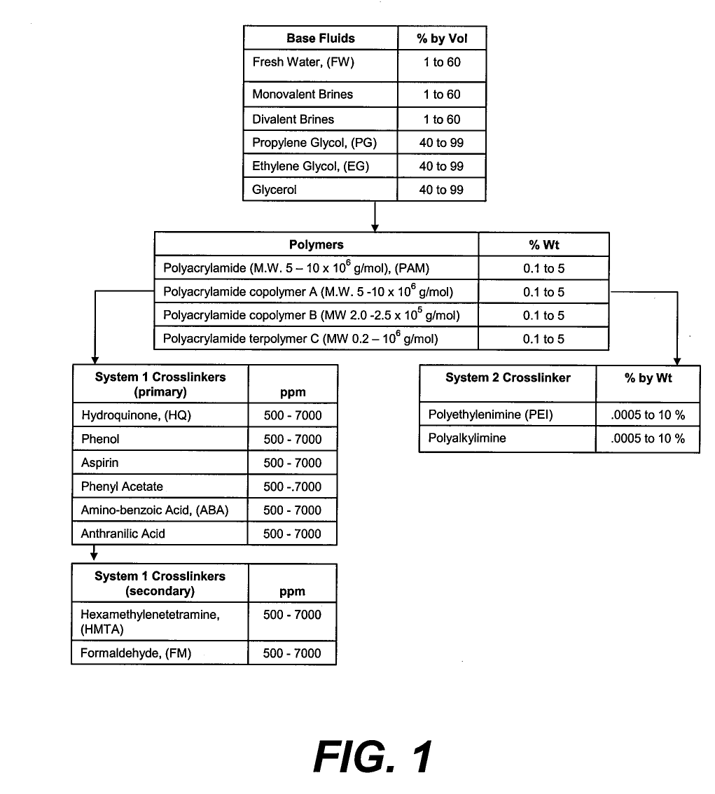

We studied the formulation and testing of various combinations of inorganic, organic, clay and polymeric materials for use as viscosifying/gelling agents in aqueous based fluids for insulating fluids. We conducted a series of tests in which the solubility, thermal conductivity, thermal stability, pH, gelling properties, rheological behavior, and toxicity of the various fluids were evaluated and compared. Perhaps most importantly, the thermal stability ranges from 37° F. to 280° F. and above were evaluated. These tests were conducted over short and long term periods. FIG. 1 lists the materials used in the formulations and the amounts tested. This in no way should construed as an exhaustive example with reference to the invention or as a definition of the invention in any way.

Thermal stability and static aging: All formulations of fluids were statically aged at temperatures≧about 280° F. for two months. Formulations and properties for the tested fluids are shown in Tables 1 and 2 below. Most of the fluids appeared to remain intact, with the crosslinked systems showing an increase in viscosity and what appeared to be complete gelation behavior. We believe that these systems appeared to exhibit more desirable stability properties than other fluids, which included numerous biopolymers (e.g., xanthan, wellan, and diutan gums) and inorganic clays and were generally destroyed after 3 days at 250° F. In addition, as to the thermal stability of these formulations tested, less than 1% syneresis was observed for any of the samples.

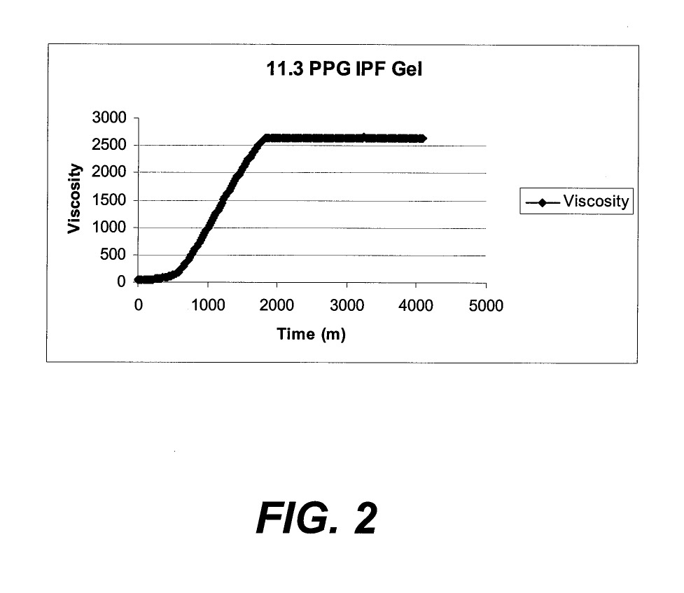

In addition to the static tests, Sample 4 was evaluated using a high-temperature viscometer to examine the thermal activation of crosslinking agents (FIG. 2). The fluid was subjected to a low shear rate at 190° F., with viscosity measurements showing an increase with time to reach the maximum recordable level around 5000 minutes.

TABLE 1
IPF Formulations and Properties Before Static Aging.

| | Sample | | | |
|---|---|---|---|---|
| | 1 | 2 | 3 | 4 |
| Formulations | | | | |
| Density, ppg | 8.5 | 10.5 | 12.3 | 11.3 |
| Water, % vol | 20 | 10 | — | 1 |
| Glycerol, % vol | — | 90 | 78.5 | 90 |
| PG, % VOL | 80 | — | — | — |
| Brine, % vol | — | — | 21.5 | 9 |
| Polymer A, % wt | 1 | 1 | 1 | — |
| Polymer B, % wt | — | — | — | 1.25 |
| Aldehyde, ppm | 5000 | 5000 | 5000 | — |
| HQ, ppm | 5000 | 5000 | 5000 | — |
| PEI, % wt | — | — | — | 2 |
| Properties | | | | |
| 300 rpm¹ | 280 | 285 | 270 | 82 |
| Shear Strength, ib/100 ft² | 13.4 | 20.65 | 20.65 | >13.4 |
| Thermal Conductivity², | 0.141 | 0.172 | 0.154 | 0.158 |
| BTU/hftF | | | | |

¹Measurements obtained from reading observed on Fann 35 viscometer, sample temperature 120° F.
²Measurements obtained by KD2-Pro Thermal Properties Analyzer.

TABLE 2
IPF Formulations and properties After 60 Days Static Aging at 280° F.

| | Sample | | | |
|---|---|---|---|---|
| | 1 | 2 | 3 | 4 |
| Formulations | | | | |
| Density, ppg | 8.5 | 10.5 | 12.3 | 11.3 |
| Water, % vol | 20 | 10 | — | 1 |
| Glycerol, % vol | — | 90 | 78.5 | 90 |
| PG, % vol | 80 | — | — | — |
| Brine, % vol | — | — | 21.5 | 9 |
| Polymer A, % wt | 1 | 1 | 1 | — |
| Polymer b, % wt | — | — | — | 1.25 |
| Aldehyde, ppm | 5000 | 5000 | 5000 | — |
| HQ, ppm | 5000 | 5000 | 5000 | — |
| PEI, % wt | — | — | — | 2 |
| Properties | | | | |
| 300 rpm³ | max | max | max | max |
| Shear Strength, ib/100 ft² | >50 | >50 | >50 | >50 |
| Thermal Conductivity, | 0.141 | 0.172 | 0.154 | 0.158 |
| BTU/hftF | | | | |

³Fluids gelled, off-scale measurement.

Thermal conductivity measurements: The importance of a low thermal conductivity (K) is an important aspect of the success of insulating fluids. For effective reduction of heat transfer, aqueous-based packer fluids in the density range of 8.5 to 12.3 ppg are expected to exhibit values for K of 0.3 to 0.2 BTU/hr ft ° F., and preferably would have lower values. From the various formulations listed above, using these formulations fluid densities of 8.5 to 14.4 ppg were observed, all of which have a thermal conductivity of<0.2 BTU/hr ft ° F. as shown in Tables 1 and 2.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Also, the terms in the claims have their plain, ordinary meaning unless otherwise explicitly and clearly defined by the patentee.

What is claimed is:

1. A method comprising:
providing an annulus between a first tubing and a second tubing;
providing an aqueous-based insulating fluid that comprises an aqueous base fluid, a water-miscible organic liquid, and a synthetic polymer; and
placing the aqueous-based insulating fluid in the annulus.

2. The method of claim 1 wherein at least a portion of the synthetic polymer is crosslinked.

3. The method of claim 1 wherein the aqueous-based insulating fluid further comprises an additive chosen from the group consisting of: corrosion inhibitors, pH modifiers, biocides, glass beads, hollow spheres, hollow microspheres, rheology modifiers, buffers, hydrate inhibitors, breakers, tracers, additional weighting agents, viscosifiers, surfactants, and combinations of these

4. The method of claim 1 wherein the aqueous base fluid comprises a brine chosen from the group consisting of: NaCl, NaBr, KCl, CaCl₂, CaBr₂, ZrBr₂, sodium carbonate, sodium formate, potassium formate, cesium formate, and combinations and derivatives of these brines.

5. The method of claim 1 wherein the water-miscible organic liquid comprises a liquid chosen from the group consisting of: esters, amines, alcohols, polyols, glycol ethers, combinations thereof and derivatives thereof.

6. The method of claim 5 wherein the polyol comprises a polyol chosen from the group consisting of: water-soluble diols; ethylene glycols; propylene glycols; polyethylene glycols; polypropylene glycols; diethylene glycols; triethylene glycols; dipropylene glycols; tripropylene glycols; reaction products formed by reacting ethylene and propylene oxide or polyethylene glycols and polypropylene glycols with active hydrogen base compounds; neopentyl glycol; pentanediols; butanediols; unsaturated diols; butyne diols; butene diols; triols; glycerols; ethylene or propylene oxide adducts; pentaerythritol; sugar alcohols; combinations thereof; and derivatives thereof.

7. The method of claim 1 or 2 wherein the synthetic polymer comprises a polymer chosen from the group consisting of: acrylic acid polymers; acrylic acid ester polymers; acrylic acid derivative polymers; acrylic acid homopolymers; acrylic acid ester homopolymers; poly(methyl acrylate); poly(butyl acrylate); poly(2-ethylhexyl acrylate); acrylic acid ester co-polymers; methacrylic acid derivative polymers; methacrylic acid homopolymers; methacrylic acid ester homopolymers; poly(methyl methacrylate); polyacrylamide homopolymer; n-vinyl pyrolidone and polyacrylamide copolymers; poly(butyl methacrylate); poly(2-ethylhexyl methacryate)); n-vinyl pyrolidone; acrylamido-methyl-propane sulfonate polymers; acrylamido-methyl-propane sulfonate derivative polymers; acrylamido-methyl-propane sulfonate co-polymers; acrylic acid/acrylamido-methyl-propane sulfonate copolymers; combinations thereof; copolymers thereof; terpolymers thereof; and mixtures thereof.

8. The method of claim 2 wherein the synthetic polymer has been crosslinked in a reaction comprising a crosslinking agent chosen from the group consisting of: a combination of a phenolic component (or a phenolic precursor) and formaldehyde (or formaldehyde precursor); polyalkylimines; non-toxic organic crosslinking agents that are free from metal ions; polyalkyleneimines; polyethyleneimine; polyalkylenepolyamines; water-soluble polyfunctional aliphatic amines; arylalkylamines; heteroarylalkylamines; combinations thereof; and derivatives thereof.

9. The method of claim 8 wherein the phenolic component or the phenolic precursor is chosen from the group consisting of: phenols; hydroquinone; salicylic acid; salicylamide; aspirin; methyl-p-hydroxybenzoate; phenyl acetate; phenyl salicylate; o-aminobenzoic acid; p-aminobenzoic acid; m-aminophenol; furfuryl alcohol; and benzoic acid.

10. The method of claim 8 wherein the formaldehyde precursor is chosen from the group consisting of: hexamethylenetetramine, glyoxal, and 1,3,5-trioxane.

11. A method comprising:
providing an apparatus comprising a tubing that comprises a first fluid located within a well bore such that an annulus is formed between the tubing and a surface of the well bore;
providing an aqueous-based insulating fluid that comprises an aqueous base fluid, a water-miscible organic liquid, and a synthetic polymer; and
placing the aqueous-based insulating fluid in the annulus.

12. The method of claim 11 wherein the synthetic polymer is crosslinked.

13. The method of claim 11 wherein the aqueous base fluid comprises a brine chosen from the group consisting of: NaCl, NaBr, KCl, CaCl₂, CaBr₂, ZrBr₂, sodium carbonate, sodium formate, potassium formate, cesium formate, and combinations and derivatives of these brines.

14. The method of claim 11 wherein the water-miscible organic liquid comprises a liquid chosen from the group consisting of. esters, amines, alcohols, polyols, glycol ethers, combinations thereof and derivatives thereof.

15. The method of claim 14 wherein the polyol comprises a polyol chosen from the group consisting of: water-soluble diols; ethylene glycols; propylene glycols; polyethylene glycols; polypropylene glycols; diethylene glycols; triethylene glycols; dipropylene glycols; tripropylene glycols; reaction products formed by reacting ethylene and propylene oxide or polyethylene glycols and polypropylene glycols with active hydrogen base compounds; neopentyl glycol; pentanediols; butanediols; unsaturated diols; butyne diols; butene diols; triols; glycerols; ethylene or propylene oxide adducts; pentaerythritol; sugar alcohols; combinations thereof; and derivatives thereof.

16. The method of claim 11 or 12 wherein the synthetic polymer comprises a polymer chosen from the group consisting of: acrylic acid polymers; acrylic acid ester polymers; acrylic acid derivative polymers; acrylic acid homopolymers; acrylic acid ester homopolymers; poly(methyl acrylate); poly(butyl acrylate); poly(2-ethylhexyl acrylate); acrylic acid ester co-polymers; methacrylic acid derivative polymers; methacrylic acid homopolymers; methacrylic acid ester homopolymers; poly(methyl methacrylate); polyacrylamide homopolymer; n-vinyl pyrolidone and polyacrylamide copolymers; poly(butyl methacrylate); poly(2-ethylhexyl methacryate)); n-vinyl pyrolidone; acrylamido-methyl-propane sulfonate polymers; acrylamido-methyl-propane sulfonate derivative polymers; acrylamido-methyl-propane sulfonate co-polymers; acrylic acid/acrylamido-methyl-propane sulfonate copolymers; combinations thereof; copolymers thereof; terpolymers thereof; and mixtures thereof.

17. The method of claim 12 wherein the synthetic polymer has been crosslinked in a reaction comprising a crosslinking agent chosen from the group consisting of: a combination of a phenolic component (or a phenolic precursor) and formaldehyde (or formaldehyde precursor); polyalkylimines; non-toxic organic crosslinking agents that are free from metal ions; polyalkyleneimines; polyethyleneimine; polyalkylenepolyamines; water-soluble polyfunctional aliphatic amines; arylalkylamines; heteroarylalkylamines; combinations thereof; and derivatives thereof.

18. A method comprising:
providing a first tubing that comprises at least a portion of a pipeline that contains a first fluid;
providing a second tubing that substantially surrounds the first tubing thus creating an annulus between the first tubing and the second tubing;
providing an aqueous-based insulating fluid that comprises an aqueous base fluid, a water-miscible organic liquid, and a synthetic polymer; and
placing the aqueous-based insulating fluid in the annulus.

19. The method of claim 18 wherein the synthetic polymer is crosslinked.

20. The method of claim 18 wherein the water-miscible organic liquid comprises a liquid chosen from the group consisting of: esters, amines, alcohols, polyols, glycol ethers, combinations thereof and derivatives thereof.

21. The method of claim 20 wherein the polyol comprises a polyol chosen from the group consisting of: water-soluble diols; ethylene glycols; propylene glycols; polyethylene glycols; polypropylene glycols; diethylene glycols; triethylene glycols; dipropylene glycols; tripropylene glycols; reaction products formed by reacting ethylene and propylene oxide or polyethylene glycols and polypropylene glycols with active hydrogen base compounds; neopentyl glycol; pentanediols; butanediols; unsaturated diols; butyne diols; butene diols; triols; glycerols; ethylene or propylene oxide adducts; pentaerythritol; sugar alcohols; combinations thereof; and derivatives thereof.

22. The method of claim 18 or 19 wherein the synthetic polymer comprises a polymer chosen from the group consisting of: acrylic acid polymers; acrylic acid ester polymers; acrylic acid derivative polymers; acrylic acid homopolymers; acrylic acid ester homopolymers; poly(methyl acrylate); poly(butyl acrylate); poly(2-ethylhexyl acrylate); acrylic acid ester co-polymers; methacrylic acid derivative polymers; methacrylic acid homopolymers; methacrylic acid ester homopolymers; poly(methyl methacrylate); polyacrylamide homopolymer; n-vinyl pyrolidone and polyacrylamide copolymers; poly(butyl methacrylate); poly(2-ethylhexyl methacryate)); n-vinyl pyrolidone; acrylamido-methyl-propane sulfonate polymers; acrylamido-methyl-propane sulfonate derivative polymers; acrylamido-methyl-propane sulfonate co-polymers; acrylic acid/acrylamido-methyl-propane sulfonate copolymers; combinations thereof; copolymers thereof; terpolymers thereof; and mixtures thereof.
